(19) United States
(12) Patent Application Publication
(10) Pub. No.: US 2014/0324461 A1
(43) Pub. Date: Oct. 30, 2014

(54) DIABETES MANAGEMENT SYSTEM WITH CONTEXTUAL DRILL DOWN REPORTS

(71) Applicant: Roche Diagnostics Operations, Inc., Indianapolis, IN (US)

(72) Inventors: Eric S. Carlsgaard, Zionsville, IN (US); Michael L. Long, Noblesville, IN (US); Stefania Marcoli, Trecate (IT); Andreas Markdalen, Monza (IT); Mark G. Mears, Westfield, IN (US); Franziska Schulz, Walldorf (DE); Dominique Steppeler, Walldorf (DE); Thomas R. Sutton, Milan (IT)

(73) Assignee: Roche Diagnostics Operations, Inc., Indianapolis, IN (US)

(21) Appl. No.: 14/172,195

(22) Filed: Feb. 4, 2014

Related U.S. Application Data
(60) Provisional application No. 61/816,651, filed on Apr. 26, 2013.

(51) Int. Cl. G06F 19/00

(52) U.S. Cl. CPC G06F 19/3487; G06F 19/322
USPC 705/3

(57) ABSTRACT

A method for displaying contextual information by a diabetes reporter of a diabetes management system is provided. The method may include: displaying a graphical representation of a plurality of data values over a period of time in a first area of an interface display; receiving a selection of a desired data value from among the plurality of data values displayed in the first area; displaying, in response to the selection, a first set of data entries and a second set of data entries in a second area of the interface display concurrently with the graphical representation of the plurality of data values in the first area of an interface display. The first set of data entries and the second set of data entries are displayed in chronological order within a preset time period.

### CROSS-REFERENCE TO RELATED APPLICATIONS

This application claims the benefit of U.S. Provisional Application No. 61/816,651, filed on Apr. 26, 2013. The entire disclosure of the above application is incorporated herein by reference.

### FIELD

The present disclosure relates to a diabetes management system, and, more particularly, to a method for displaying contextual information by way of a user interface.

### BACKGROUND

Management of chronic illness, like diabetes, involves collecting and analyzing large amount of data. Such data may be acquired from medical devices, personal healthcare devices, patient recorded information, and test results. For people with diabetes, successful management requires monitoring the effects lifestyle changes can have in both the short term and long term. As much as tested health parameters are important in managing a chronic illness, so are one's daily activities. For example, a patient's meals, physical activity, prescription drug dosage, and even emotional state, play a role in managing one's illness.

As a tool for understanding lifestyle changes on one's health, patients may access and run a variety of reports which aggregate and present diagnostic data over a preset time period, such as a day, a week, or a month. Such reports may be accessed via a user interface that is supported by, for example, a diabetes management system. The user interface may present statistical reports, allowing the user to gauge, for example, one's glucose level for a 24 hour period. The user interface should not only present statistical data, but also associate such data with lifestyle changes.

This section provides background information related to the present disclosure which is not necessarily prior art.

### SUMMARY

This section provides a general summary of the disclosure, and is not a comprehensive disclosure of its full scope or all of its features.

A computer implemented method for displaying contextual information by a diabetes reporter of a diabetes management system based on data entries stored in a database is provided in the present disclosure.

The method may include: displaying, by the diabetes reporter, a graphical representation of a plurality of data values over a period of time in a first area of an interface display, wherein the diabetes reporter is implemented as instructions executed by a computer processor; receiving, by the diabetes reporter via an input terminal, a selection of a desired data value from among the plurality of data values displayed in the first area; retrieving, by the diabetes reporter from the database, a first set of data entries and a second set of data entries in response to the selection of the desired data value, wherein the first set of data entries are associated with the desired data value and the second set of data entries are for other data entries that are within a preset time period of the desired data value; and displaying, by the diabetes reporter, the first set of data entries and the second set of data entries in a second area of the interface display concurrently with the graphical representation of the plurality of data values in the first area of the interface display, wherein the second area is spatially exclusive from the first area, and the first set of data entries and the second set of data entries are displayed in chronological order within the preset time period.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a functional block diagram of a diabetes management system;

FIG. 2 is functional block diagram of the diabetes management system in communication with a medical device and a computing device;

FIGS. 3A and 3B illustrate a user interface adapted for a computing device;

FIG. 4 illustrates an example of the user interface provided by a diabetes reporter of the diabetes management system;

FIG. 5 illustrates an example of the user interface with a drill-down area;

FIGS. 6A and 6B illustrate an example of the drill-down area;

FIG. 7 illustrates an example of a window of the drill-down area;

FIG. 8 is a table of example guidelines for displaying contextual information for specific data entries;

FIGS. 9A, 9B, 9C and 9D illustrate examples of various data entries presented in the window;

FIG. 10 illustrates an example of the user interface displaying a report;

FIG. 11 illustrates an example of the user interface of FIG. 10 with the drill-down area and a selected data value; and

FIG. 12 illustrates an example of the drill-down area.

Corresponding reference numerals indicate corresponding parts throughout the several views of the drawings.

### DETAILED DESCRIPTION

The present disclosure will now be described more fully with reference to the accompanying drawings.

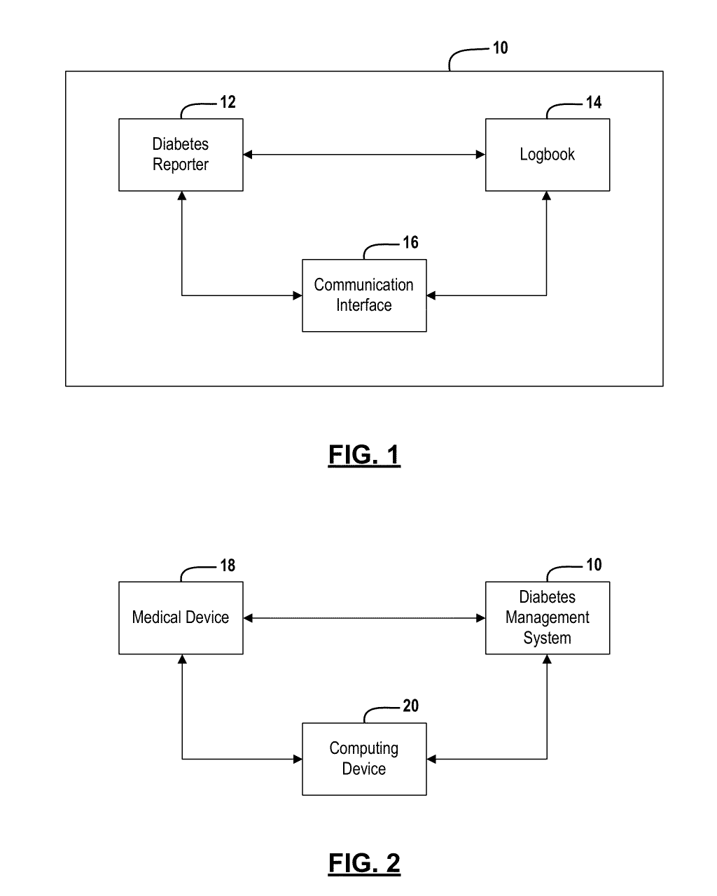

With reference to FIGS. 1 and 2, an example of a diabetes management system 10 is now presented. The diabetes management system 10 includes software tools that enable healthcare providers and patients to manage diabetes. For example, the diabetes management system 10 may include a diabetes reporter 12, a logbook 14, and a communication interface 16. The diabetes management system 10 may be housed in one or more servers.

The diabetes management system 10 may exchange information with various devices via the communication interface 16. For example, the communication interface 16 may establish a communication link to a communication network, such as the Internet. The communication interface 16 allows external devices to access the software tools of the diabetes management system 10 via the communication network.

The diabetes management system 10 may exchange information with, for example, a medical device 18 and/or a computing device 20 by way of the communication interface 16. The medical device 18 may be a glucose meter, an insulin pump, a blood pressure monitoring device, a thermometer, and/or other suitable instruments for diagnosing and/or treating a health condition. Such medical devices 18 may transmit data to the diabetes management system 10, as a data entry.

The computing device 20 may be used by a user to access data entries and software tools provided by the diabetes management system 10. For example, the user may use the computing device 20 to select various tools being displayed on a screen of the computing device 20. The computing device 20 may be a computer, a smart phone, a tablet, or other suitable device able to access the diabetes management system 10.

While the medical device 18 may automatically transmit information to the diabetes management system 10, the user may also transmit data captured by the medical device 18 via the computing device 20. For example, the medical device 18 may be communicably coupled to the computing device 20 via a wireless communication link or a wired communication link. The computing device 20 may then access the diabetes management system 10 via the communication network and the communication interface 16. Using the computing device 20, the user may also provide additional information to the diabetes management system 10 regarding the user's daily activities. For example, the user may be able to enter data regarding meals, exercise, emotional state, and other patient activities as a data entry.

Data entries received by the diabetes management system 10 may be stored in the logbook 14. The data entry may include information identifying the type of data captured, a numerical measurement, a unit of measurement, a timestamp identifying the date and time the data entry was captured, and or other suitable information related to the type of data captured. For example, the data entry may be a glucose measurement (type of data) having a numerical measurement and unit of measurement of 169 mg/dl, and timestamp of 12:20 pm, Wednesday Jul. 15, 2012. Glucose measurement may encompass, for example, continuous glucose measurement (CGM) and/or blood glucose. Some data entries may not include such information. For example, a data entry identified as an emotional state does not include a numerical measurement or unit of measurement. Instead, the data entry may include a text string entered or selected by the user, such as “happy” or “sad”.

The diabetes reporter 12 defines a user interface (i.e., interface display) for allowing a user to access the data entries stored in the logbook 14 and to analyze the data entries. The user may access the diabetes reporter 12 via the computing device 20. The diabetes reporter 12 may allow the user to run a series of reports and then display such reports on the user interface. The diabetes reporter 12 may be implemented as instructions executed by a computer processor.

The reports are defined by a series of instructions stored and executed by the diabetes management system 10. Each report may perform statistical analyses of predefined data entries and present the finding in the form of one or more chart and/or graph. More particularly, the reports present data values of certain data entries over a period of time. The data values are represented by indicia, such as a dot, a bar, or other suitable indicators. For example, a report for standard day may present data entries related to glucose measurement, carbohydrates, and insulin dosage in separate charts. Each chart may present data over a 24 hour period and include data for multiple days laid on top of each other. It would be appreciated by one skilled in the art that the diabetes management system 10 may store and execute various types of reports and other statistical information via the diabetes reporter 12 and is not limited to the reports and information described herein.

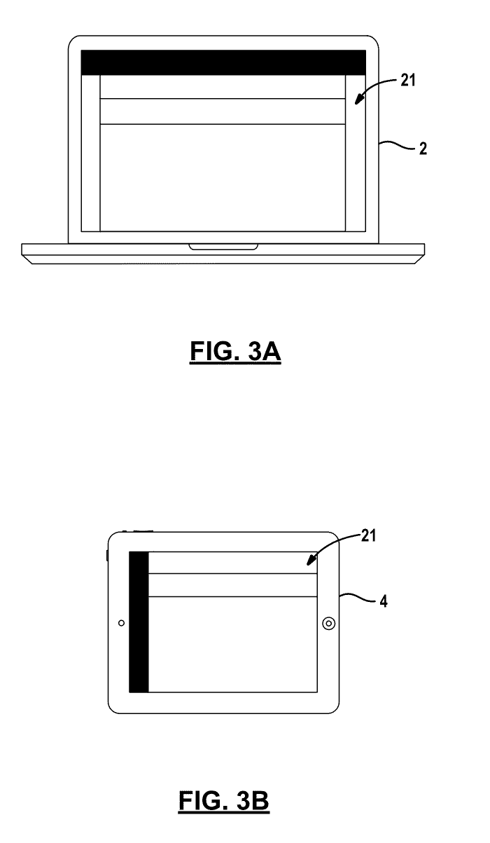

With reference to FIGS. 3A and 3B, an example of a user interface 21 is now presented. As illustrated, the user interface 21 may be adapted for various types of computing devices 20. For example, the user interface 21 may be adapted for a laptop 2 (FIG. 3A) and a tablet 4 (FIG. 3B). While the user interface 21 is illustrated with respect to a laptop 2 and the tablet 4, it will be appreciated by one skilled in the art that the user interface 21 may also be adapted for other computing devices 20 such as a smart phone.

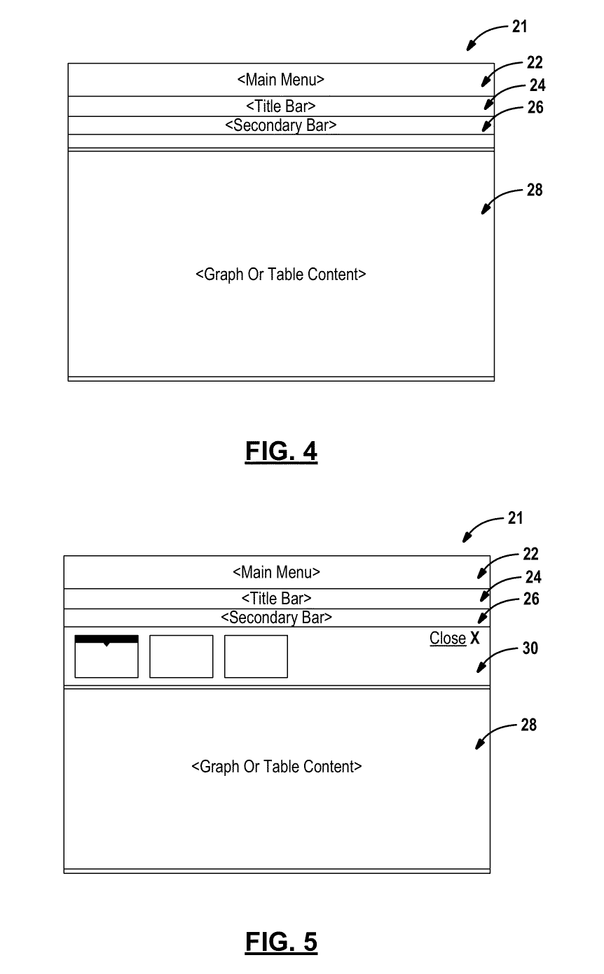

With reference to FIGS. 4 and 5, the user interface 21 is segmented into multiple areas. For example, the user interface may include a main menu 22, a title bar 24, a secondary bar 26, and a digest area 28. In the example shown in the following figures, text displayed between “< . . . >” are provided as place holders and are not displayed by the user interface 21.

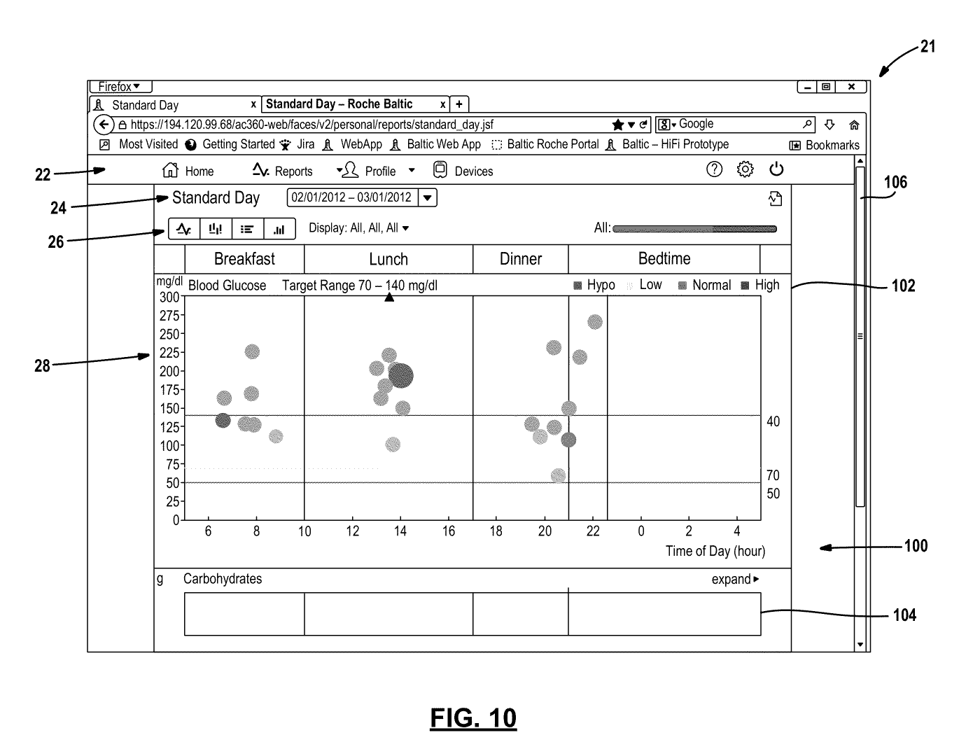

The main menu 22 may continuously be displayed on the user interface 21. The main menu 22 may display drop down menus accessible by the user. For example, the main menu 22 may include a drop down menu titled “Reports” (FIG. 10). The drop down menu for “Reports” lists the various reports available to the user via the diabetes management system 10.

The title bar 24 may display contextual information regarding the information currently being displayed in the digest area 28. For example, the title bar 24 may display the name of a report which is being displayed. The secondary bar 26 displays buttons for controlling the data being displayed in the digest area 28. The digest area 28 presents information outputted by a report. For example, the digest area 28 may display one or more graphs outputted by the report selected.

The user interface 21 also includes a drill-down area 30. The drill-down area 30 is positioned below the secondary bar 26. As described in further detail below, the drill-down area 30 fades in below the secondary bar 26 when a data value presented in the digest area 28 is selected by the user. The drill-down area 30 may extend across an axis parallel with a width of the user interface 21. The drill-down area 30 presents contextual information of the user's daily activities for a preset time period.

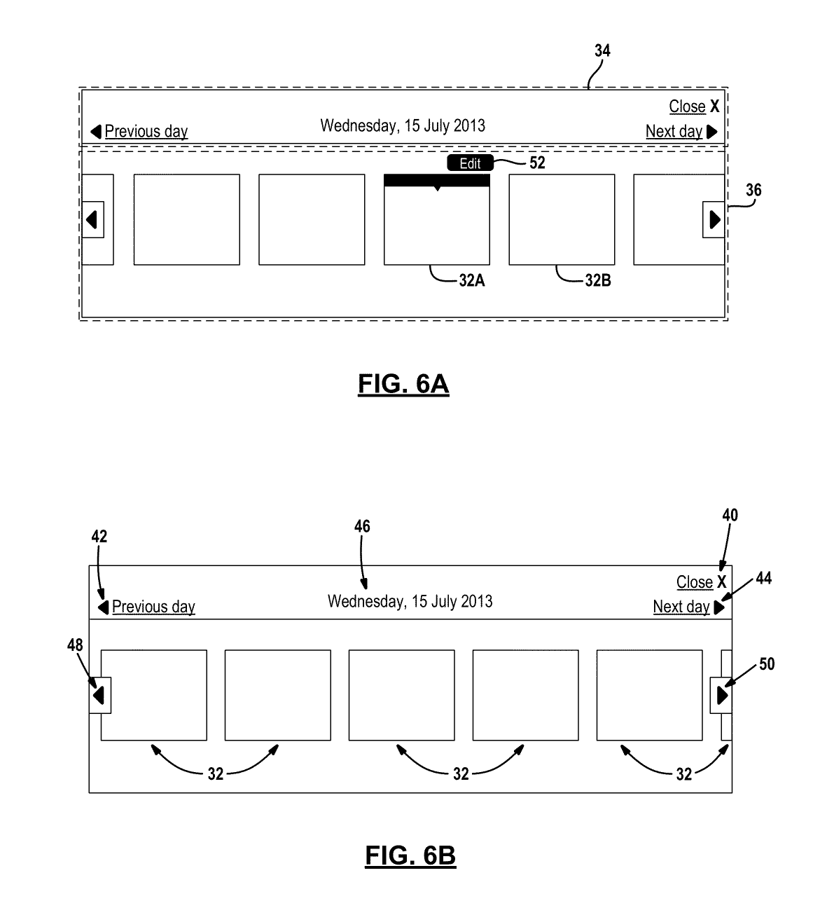

With reference to FIGS. 6A and 6B, an example of the drill-down area 30 is described in further detail. The drill-down area 30 displays a plurality of windows 32 which provide contextual information of various data entries entered by the user for a specific day. More particularly, when a data value is selected, the diabetes reporter 12 identifies certain data entries stored in the logbook 14. Such data entries may include a first set of data entries and a second set of data entries. The diabetes reporter 12 may then present contextual information regarding the first set and the second set of data entries as described in detail below.

The first set of data entries may be data entries that are associated with the data value selected. For example, the first set of data entries may be data entries that are entered or have the same timestamp as the data value selected. In other words, in the example embodiment, the data entries may be associated with one another when the timestamp of the data entries are the same. The data entries may be associated with one another based on another parameter, and is not limited to the time at which the data entry was captured.

The second set of data entries may be data entries captured within a preset time period of the data value selected. For example, the second set of data entries may include data entries captured within a few minutes, a few hours, or the same day as the data value selected.

As shown in FIGS. 6A and 6B, the drill-down area 30 may be viewed as having a header region 34 and a content region 36. The header region 34 may include a close button 40, a previous day button 42, and a next day button 44. In the example of FIGS. 6A and 6B, the terms “Close”, “Previous day”, and “Next day” are provided next to the buttons 40, 42, 44. Alternatively, the terms may not be displayed in the header region 34. For example, the diabetes reporter 12 may display the terms when the user hovers a pointer over the buttons 40, 42, 44.

The close button 40 fades out the drill-down area 30 from under the secondary bar 26 when operated. If the previous day button 42 is operated, the drill-down area 30 is updated and presents data entries associated with the day before the current day being displayed. Similarly, when the next day button 44 is operated, the drill-down area 30 is updated and presents data entries associated with the day after the current day being displayed.

As provided above, the windows 32 are arranged in chronological order within the content region 36. In response to the operation of the previous day button 42 or the next day button 44, the drill-down area 30 may initially center the content region 36 with a particular set of windows 33. For example, the drill-down area 30 may initially focus on the windows 32 that present contextual information of data entries that correspond with the data value selected. Specifically, data entries that were captured around the same time of day as the data value selected may be centered within the content region 36. Alternatively, the drill-down area 30 may initially focus at the beginning of the day. Thus, the first window displayed on the left side of the content region 36 would have contextual information of the first data entry of the day.

In addition to buttons 40, 42, 44, the header region 34 further includes a date label 46. The date label 46 displays contextual information regarding the current day being displayed. For example, the date label 46 may display the date of the data entries depicted in the plurality of windows 32. The date may be identified by the timestamp associated with the data value selected and/or the data entries being displayed.

The content region 36 includes the windows 32 and may include a back button 48 and a forward button 50. The back button 48 and forward button 50 allow the user to navigate across the plurality of windows 32. Specifically, the plurality of windows 32 are arranged in chronological order within the content region 36. Accordingly, the back button 48 and the forward button 50 allow the user to scroll across the data entries presented by the plurality of windows 32. While the back button 48 and the forward button 50 are depicted in the example of FIGS. 6A and 6B, it would be appreciated by one skilled in the art that the back button 48 and the forward button 50 may not be depicted if the plurality of windows 32 fit within the content region 36 defined by the user interface 21. In addition, in lieu of the back button 48 and the forward button 50, a scroll bar may be disposed below the windows 32. As another alternative, if the computing device 20 includes a touch screen display, such as a tablet, the user may simply perform a swipe or slide movement with their finger along a surface of the display to scroll through the windows 32.

As provided above, the windows 32 are arranged in chronological order within the drill-down area 30. When the data value is selected in the digest area 28, the window 32 associated with the data value is emphasized or highlighted. Specifically, the first set of data entries retrieved may be emphasized and displayed differently in the drill-down area 30 than the second set of data entries. For example, with reference to FIG. 6A, a window 32 may be displayed in a first display state 32A or a second display state 32B which is different from the first display state 32A.

The first display state 32A may be used to display the first set of data entries and the second display state 32B may be used to display the second set of data entries. Various suitable display methods may be used to emphasize or highlight the window 32 in the first display state 32A. For example, in the first display state, the window 32 may include a thicker border or appear in a darker color than the second display state 32B.

Once, the drill-down area 30 is displayed, the windows 32 may be selected by the user (a selected window 32). In the event that the user selects one of the windows 32, the diabetes reporter 12 may display the selected window 32 in the first display state 32A. Specifically, windows 32 currently being displayed in first display state 32A are switched to the second display state 32B, and the selected window 32 is displayed in the first display state 32A. The diabetes reporter 12 may also display the windows 32 that present data entries associated with the selected window 32 in the first display state 32A.

When the window 32 is displayed in the first display state 32A an edit button 52 may be displayed above the window 32. By operating the edit button 52, a dialog box related to the data entry represented by the window 32 is displayed. The user may edit information regarding the data entry via the dialog box.

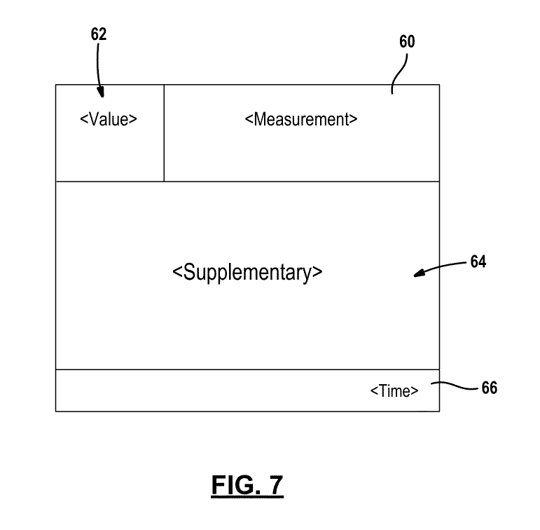

With reference to FIGS. 7-9G, examples of the windows 32 and contextual information displayed by the windows 32 is now presented. The window 32 may include a measurement section 60, a value section 62, a supplementary section 64, and a time label 66. The measurement section 60 may provide a short description of the data entry represented by the window 32. The value section 62 displays the numerical measurement regarding the data entry represented by the window 32 if appropriate.

The supplementary section 64 may display additional information regarding the data entry. For example, the supplementary section 64 may display contextual information, a picture uploaded by a user, an icon, or a default picture. The time label 66 is positioned below the supplementary section 64. The time label 66 presents the time at which the data entry was captured which may be extracted from the timestamp of the date entry.

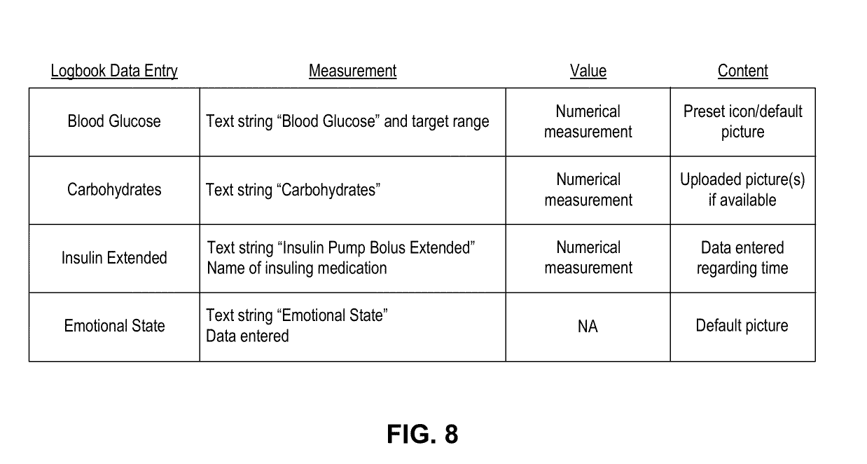

The diabetes reporter 12 may include predefined guidelines outlining the contextual information to be displayed in each of the sections of the window 32 for each data entry. For example, as shown in FIG. 8, a table defines contextual information displayed for data entries related to blood glucose, carbohydrate, insulin pump bolus extended, and emotional state. For a data entry related to blood glucose, the measurement section 60 displays “Blood Glucose” and data reflective of the target range of the blood glucose, such as “high”, “normal”, or “low”. The value section 62 displays the numerical measurement provided in the data entry. The supplementary section 64 displays an icon or a default picture.

In another example, for a data entry related to emotional state, the measurement section 60 displays “Emotional State” and a text string reflective of the data entered by the user, such as “happy”, “sad”, “content”. Since there is no numerical measurement provided with emotional state, the value section 62 is empty. The supplementary section 64 may display a default picture.

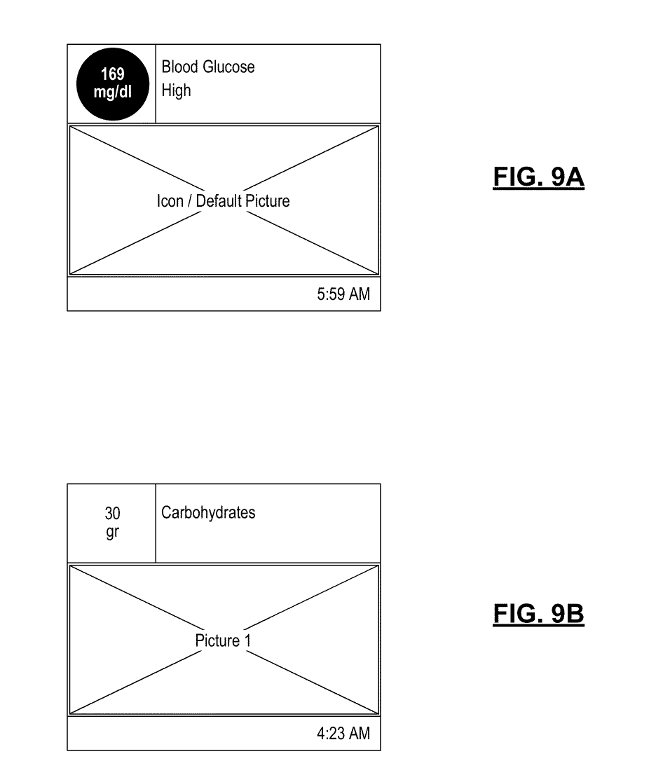

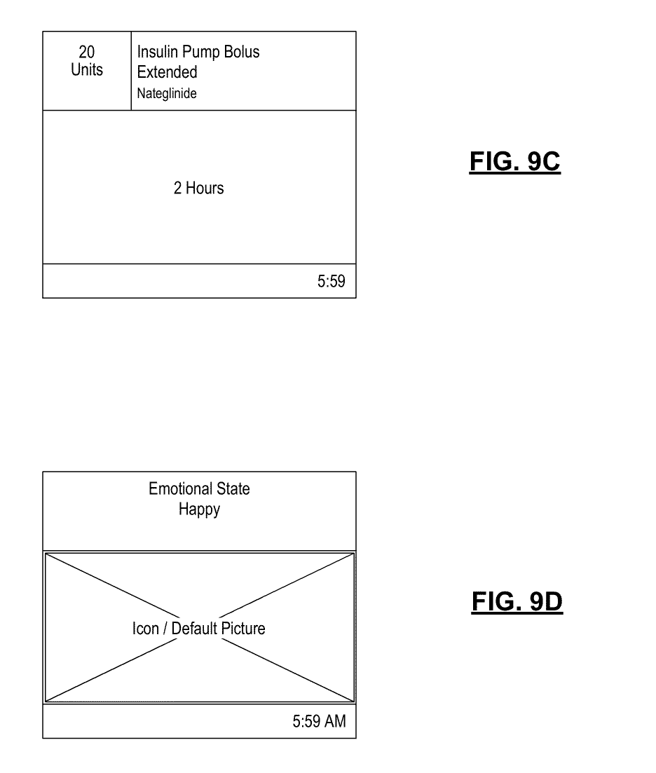

FIGS. 9A-9D show examples of the window 32 providing contextual information for data entries related to blood glucose, carbohydrates, insulin pump bolus extended, and emotional state, respectively. In FIGS. 9A-9D in lieu of depicting an icon, default picture, or picture, the figures provide a place holder identified as “Icon/Default Picture” or “Picture”. As shown in the examples, for certain data entries, the window 32 may include the measurement section 60 and the value section 62. On the other hand, if the value section 62 does not provide information, the measurement section 60 may extend into the value section 62, as shown in FIG. 9D. It would be appreciated by one skilled in the art that the diabetes reporter 12 may define guidelines for other data entries and are not limited to the data entries described herein. While the window 32 is configured to include the sections described herein, the window 32 may be configured in other suitable ways.

With reference to FIGS. 10-12, an exemplary operation of the drill-down area 30 by the diabetes reporter 12 is now described. As shown in FIG. 10, the user interface 21 displays an example of a standard day report 100. The diabetes reporter 12 displays “Standard Day” in the title bar 24 and multiple charts outputted by the standard day report 100 in the digest area 28. For example, the digest area 28 displays a blood glucose chart 102 and a carbohydrates chart 104, which may be viewed by the user by moving a scroll bar 106. In the standard day report 100, the dots representing the data values for various blood glucose data entries may be displayed in different colors based on the data value. For example, a glucose measurement that is identified as hyper may be displayed in a color different from a glucose measurement that is identified as normal.

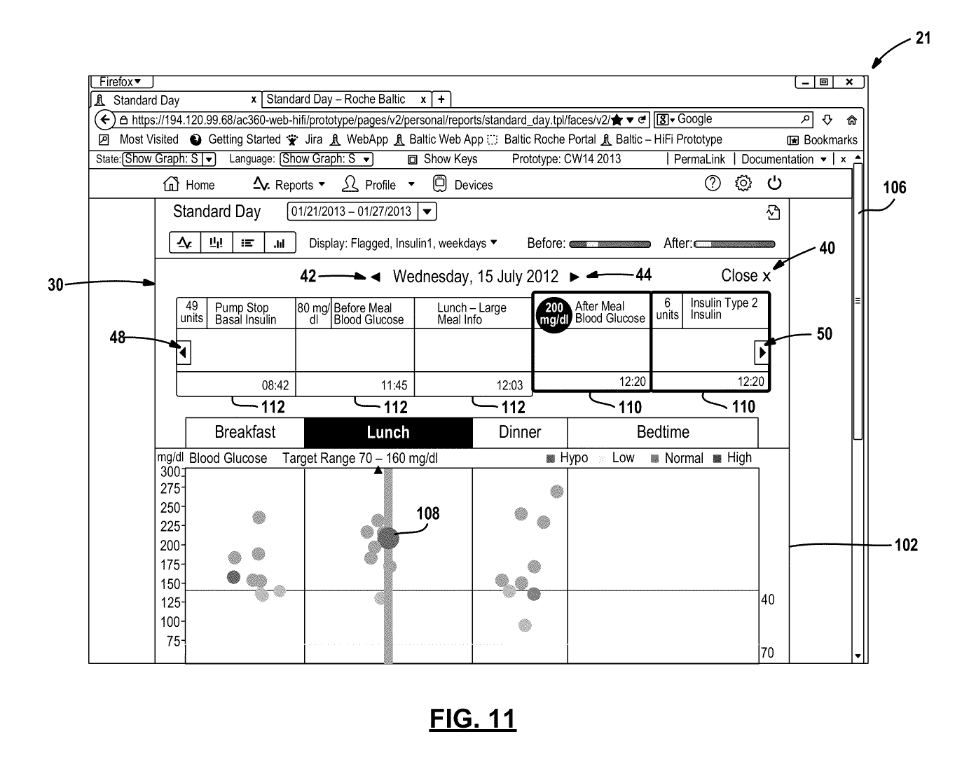

The user may select a data value in either one of the charts 102, 104 being displayed. For example, in FIG. 11, the user selects a data value (i.e., desired data value 108) in the blood glucose chart 102. The desired data value 108 is highlighted in the blood glucose chart 102, thereby providing visual indication of which data value was selected. In addition, the size of the dot representing the desired data value 108 may be increased to further emphasize the desired data value 108, and may remain increased as long as it is the desired data value 108.

In response to the selection of the desired data value 108, the diabetes reporter 12 retrieves the first set of data entries and the second set of data entries from the logbook 14. Using the predefined guidelines, the diabetes reporter 12 generates the window 32 for each of the data entries retrieved.

The diabetes reporter 12 displays the drill-down area 30 with the windows 32 between the secondary bar 26 and the digest area 28. By inserting the drill-down area 30, the blood glucose chart 102 and the carbohydrates chart 104 are shifted downward. As a result, the scroll bar 106 may be adjusted to allow a user to scroll through the user interface 21.

The diabetes reporter 12 arranges the windows 32 provided in the drill-down area 30 in chronological order. The diabetes reporter 12 arranges the windows 32 representative of the data entries retrieved within the preset time period. For example, the drill-down area 30 displays the data entries for a specific day (e.g., Wednesday 15 Jul., 2012).

The diabetes reporter 12 displays the window 32 that presents contextual information of the first set of data entries in the first display state. For example, in the example of FIG. 11, the window 32 having the contextual information of the desired data value 108 and an associated data entry (core windows 110) are displayed in a first display state. The windows 32 that display contextual information of the second set of data entries are displayed in a second display state (supporting window 112).

In the example of FIG. 11, the first set of data entries includes two data entries (the desired data value 108 and the associated data entry related to insulin type). The first set of data entries may include additional data entries or may only include the desired data value 108. Accordingly, one or more windows 32 may be displayed in the first display state. In addition, for the sake of brevity, the edit button 52 is not shown above the core windows 110.

The drill-down area 30 further includes the back button 48 and the forward button 50. The back button 48 and the forward button 50 allow the user to scroll through the data entries captured within the day identified in the data label 46. Accordingly, the diabetes reporter 12 provides detailed contextual information regarding the activity of the user in the form of a time line.

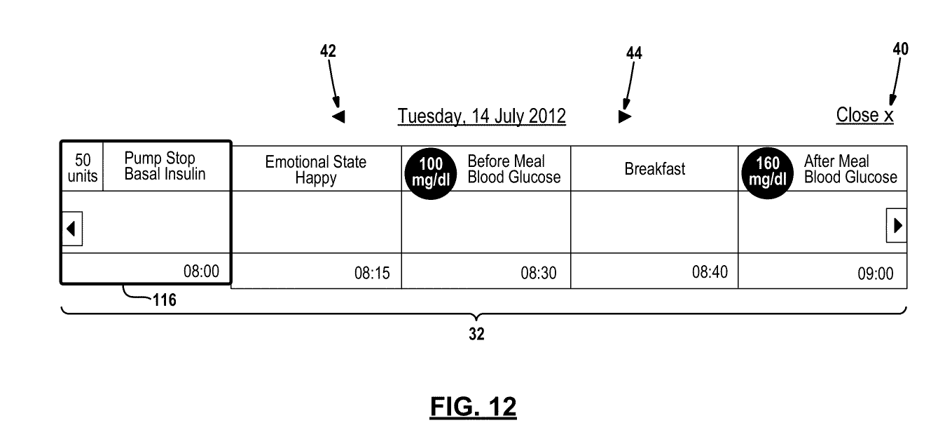

As described above, the user is able to view detailed information of other days by operating the previous day button 42 and the next day button 44. For example, when the user operates the previous day button 42, the diabetes reporter 12 updates the drill-down area 30. Specifically, as shown in FIG. 12, the diabetes reporter 12 displays windows 32 that provide contextual information of the data entries captured the previous day (e.g., Tuesday 14 Jul., 2012). The drill-down area 30 may initially focus the content region 36 at the beginning of the day. In addition, the diabetes reporter 12 may display the window 32 which provides the contextual information of the first data entry of the day in the first display state (identified as window 116 in FIG. 12).

Based on the operations performed by the user via the computing device 20, the diabetes reporter 12 may update the content of the drill-down area 30. For example, if the user updates filter for a specific report, the drill-down area 30 may be updated based on the changes. The diabetes reporter 12 may close the drill-down area 30 when the close button 40 is operated.

In addition, the diabetes reporter 12 may also update the charts/graphs in the digest area 28 based on the operations performed in the drill-down area 30. For example, if the user operates the previous day button 42, the charts presented in the digest area 28 are updated accordingly. Furthermore, when a data value is selected, the diabetes reporter 12 may highlight the time period associated with the data value. For example, in FIG. 11, the desired data value 108 is provided in the “Lunch” time period which is highlighted or emphasized. Accordingly, the diabetes reporter 12 further correlates the information presented in the digest area 28 with the information presented in the drill-down area 30. The diabetes reporter 12 may perform other controls for correlating the digest area 28 with the drill-down area 30.

The diabetes management system 10 presents information regarding a user's daily activity and health parameters, such as blood glucose measurements, in an organized manner. Specifically, the user interface 21 provides access to various reports that present data values of certain data entries in graphical form. By selecting a desired data value from a chart/graph, the user is presented with a plurality of windows that present contextual information of data entries entered by the user within, for example, a specific data. The data entries presented include health parameters and daily activities of the user. Accordingly, the user is able to associate a desired data value with events of a particular day which help to reinforce good lifestyle practices.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, and/or sections, these elements, components, regions, and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, or section discussed below could be termed a second element, component, region, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly. As used herein, the term “and/or” includes any and all combinations of one or more of the associated listed items.

What is claimed is:

1. A computer implemented method for displaying contextual information by a diabetes reporter of a diabetes management system based on data entries stored in a database, comprising:
displaying, by a diabetes reporter, a graphical representation of a plurality of data values over a period of time in a first area of an interface display, wherein the diabetes reporter is implemented as instructions executed by a computer processor;
receiving, by the diabetes reporter via an input terminal, a selection of a desired data value from among the plurality of data values displayed in the first area;
retrieving, by the diabetes reporter from the database, a first set of data entries and a second set of data entries in response to the selection of the desired data value, wherein the first set of data entries are associated with the desired data value and the second set of data entries are for other data entries that are within a preset time period of the desired data value; and
displaying, by the diabetes reporter, the first set of data entries and the second set of data entries in a second area of the interface display concurrently with the graphical representation of the plurality of data values in the first area of the interface display, wherein the second area is spatially exclusive from the first area, and the first set of data entries and the second set of data entries are displayed in chronological order within the preset time period.

2. The method of claim 1 wherein the first set of data entries are highlighted from the second set of data entries during the displaying of the first set of data entries and the second set of data entries in the second area of the interface display.

3. The method of claim 1 further comprising:
displaying, by the diabetes reporter, a scroll interface in the second area wherein the scroll interface moves the data entries displayed in the second area of the interface display when operated via the input terminal.

4. The method of claim 1 wherein the displaying, by the diabetes reporter, the first set of data entries and the second set of data entries in the second area of the interface display further comprises:
extracting, by the diabetes reporter, contextual information from the first set of data entries and the second set of data entries, and
displaying, by the diabetes reporter, the contextual information from the first set of data entries and the second set of data entries in a plurality of windows arranged in the second area of the interface display.

5. The method of claim 4 wherein the plurality of windows are arranged in chronological order along a first axis parallel with a width of the second area of the interface display.

6. The method of claim 1 wherein the data entries retrieved by the diabetes reporter includes a glucose measurement, an insulin dosage, and a carbohydrate intake.

7. The method of claim 1 wherein the second area of the interface display is above the first area of the interface display.

8. The method of claim 1 wherein the second area of the interface display includes a header region and a content region, and the method further comprises:
displaying, by the diabetes reporter, the first set of data entries and the second set of data entries in the content region of the second area;
displaying, by the diabetes reporter, a text string representative of the preset time period of the desired data value in the header region of the second area, and
updating, by the diabetes reporter, the content region of the second area in response to the selection of another data value, as the desired data value.

9. A diabetes management system comprising:
a communication interface communicably coupled to an external device via a communication network;
a logbook storing a plurality of data entries received from the external device via the communication interface; and
a diabetes reporter configured to display an interface display on a display of a computing device for presenting contextual information based on the plurality of data entries, wherein
the diabetes reporter displays a plurality of data values over a period of time in a first area of the interface display and displays a first set of data entries and a second set of data entries in a second area of the interface display when a desired data value is selected from among the plurality of data values displayed in the first area, the second area is positioned below the first area of the interface display, the first set of data entries and the second set of data entries are among the plurality of data entries stored in the logbook, and
the diabetes reporter displays the first set of data entries and the second set of data entries in chronological order within the second area of the interface display.

10. The diabetes management system of claim 9 wherein the first set of data entries are associated with the desired data value and the second set of data entries are for other data entries that are within a preset time period of the desired data value.

11. The diabetes management system of claim 9 wherein the first set of data entries are displayed in a first display setting and the second set of data entries are displayed in a second display setting different from the first display setting, such that the first set of data entries are highlighted from the second set of data entries.

12. The diabetes management system of claim 9 wherein the diabetes reporter displays a scroll interface in the second area of the interface display, and the scroll interface moves the data entries displayed in the second area of the interface display when operated via the computing device.

13. The diabetes management system of claim 9 wherein the diabetes reporter displays a plurality of windows arranged in the second area of the interface display, and the plurality of windows includes contextual information from the first set of data entries and the second set of data entries.

14. The diabetes management system of claim 13 wherein the plurality of windows are arranged in chronological order along an axis parallel with a width of the second area of the interface display.

15. The diabetes management system of claim 9 wherein the data entries stored in the logbook includes a glucose measurement, an insulin dosage, and a carbohydrate intake.

16. The diabetes management system of claim 9 wherein the computing device, as the external device, accesses the diabetes reporter via the communication interface.

17. The diabetes management system of claim 9 wherein the external device is a medical device.
